(19) United States
(12) Patent Application Publication
(10) Pub. No.: US 2024/0396180 A1
(43) Pub. Date: Nov. 28, 2024

(54) CURRENT COLLECTOR

(71) Applicant: Taicang Manaflex Technology Co., Ltd., Taicang City (CN)

(72) Inventors: Robert C. LANE, Las Vegas, NV (US); Yifei LIU, Toronto (CA); Shaodan XU, Suzhou (CN)

(21) Appl. No.: 18/672,205

(22) Filed: May 23, 2024

(30) Foreign Application Priority Data
May 24, 2023 (CN) 202321270090.7

(51) Int. Cl. H01M 50/526; H01M 50/503; H01M 50/505

(52) U.S. Cl. CPC H01M 50/526; H01M 50/503; H01M 50/505

(57) ABSTRACT

A current collector includes successive layers, which includes a first insulating layer, a reinforcement layer, a bus layer and a second insulating layer that are stacked. Several electrode connection parts are provided in the bus layer. The reinforcing layer includes a first reinforcing plate and a second reinforcing plate arranged at intervals. Each layer is provided with a first hole corresponding to an electrode connection part. The current collector has a simple structure, and includes reinforcing layers that are formed mutually independent of each other, and includes a first reinforcing plate and a second reinforcing plate. The gap between the first reinforcing plate and the second reinforcing plate can be bent arbitrarily.

### CROSS-REFERENCE TO RELATED APPLICATION

This application claims priority under 35 U.S.C. § 119 to Chinese Utility Model application No. 202321270090.7 filed on May 24, 2023, the disclosure of which is hereby incorporated by reference in its entirety for all purposes.

### FIELD OF INVENTION

The disclosure model relates to the technical field of new energy batteries, and in particular to a current collector.

### BACKGROUND

A general battery module includes a casing and a number of battery cells/cylindrical batteries arranged in the casing. The battery cells/cylindrical batteries include pools that are connected as a whole through current collectors. In actual production, the current collector is usually made of 0.15 mm thick aluminum foil, which is very fragile and easily damaged and needs to be protected by a reinforced layer. During the production, transportation and storage of current collectors, in order to reduce production difficulty and save space, it is in a flat state and needs to be bent during installation. The presence of the reinforcement layer makes bending difficult. Therefore, improvements need to be made.

### SUMMARY

The disclosure relates to a current collector that overcome the deficiencies in conventional systems.

To achieve the above object, the present invention provides the following technical solutions:

In one embodiment, a current collector includes a bus plate, which includes a first insulating layer, a reinforcement layer, and a bus layer that are stacked in sequence. A second insulating layer and a plurality of electrode connection parts are provided in the bus layer, and the reinforcement layer includes first reinforcement layers arranged at intervals. A second reinforcing plate is also provided. The first reinforcement plate and the second reinforcing plate, the first insulating layer, the first reinforcing plate and the second insulating layer are all provided with electrodes connected to the electrodes. There first mounting hole corresponding to the connecting part or mounting portion.

Further, in the above-mentioned current collector plate, an installation portion protrudes from one end of the current collector layer close to the second reinforcing plate, a first mounting hole is provided in the mounting part or mounting portion, and a second mounting hole coaxial with the first mounting hole is provided in the second reinforcing plate.

Further, in the above-mentioned current collector, the first mounting hole and the second mounting hole are both oval-shaped holes.

Further, in the above-mentioned current collector, the mounting portion and the second reinforcing plate extend away from the first reinforcing plate. One end of the mounting portion and the second reinforcing plate protrudes from the first insulating layer and the second insulating layer.

Further, in the above-mentioned bus plate or current connector, the side of the second insulating layer facing away from the bus layer is provided with glue or other adhesive material. An adhesive layer is provided, with the side of the adhesive layer facing away from the second insulating layer being provided with a peeling layer, and the adhesive layer and the peeling layer are provided. There is a second mounting hole corresponding to the electrode connection part.

Further, in the above-mentioned busbar, a peeling strip protrudes from one end of the peeling layer.

Further, in the above-mentioned bus plate, the first insulating layer, the first reinforcing plate, the bus layer, the second insulating layer include coaxial positioning holes that are also provided in the adhesive layer and the peeling layer.

Compared with conventional systems, the advantage of the current collector disclosed herein is: it has a simple structure, and the reinforcing layers are formed mutually independent of each other. The current collector includes an independent first reinforcing plate and a second reinforcing plate. The current collector can be arbitrarily arranged along the gap between the first reinforcing plate and the second reinforcing plate. Accordingly, the current collector is bendable for easy installation.

### BRIEF DESCRIPTION OF THE DRAWINGS

In order to more clearly illustrate the embodiments of the present invention or the technical solutions in the prior art, the following examples or the drawings provided. Obviously, the drawings in the following description are only some possible embodiments. For those of ordinary skill in the art, without exerting creative efforts, other drawings can be contemplated and are within this disclosure.

FIG. 1 shows a flat state diagram of the current collector in a specific embodiment of the present invention.

FIG. 2 shows a schematic structural diagram of the bus layer in a specific embodiment of the present invention.

FIG. 3 shows a schematic structural diagram of the reinforcing layer in a specific embodiment of the present invention.

FIG. 4 shows an enlarged schematic diagram of position 1 in FIG. 1.

FIG. 5 shows a bending state diagram of the current collector in a specific embodiment of the present invention.

### DETAILED DESCRIPTION

Below, in conjunction with the accompanying drawings in the embodiments of the present disclosure, the technical solutions in the embodiments of the present disclosure are carried out. This detailed description of the described embodiments are only part of the embodiments of the present invention, rather than all example implementations. Based on the embodiments of the present invention, those of ordinary skill in the art can make the all other obtained embodiments belong to the protection scope of the present disclosure.

In the description of the present invention, it should be noted that the terms “center”, “upper”, “lower”, “left”, “right”, and “vertical”, as well as the orientations or positional relationships indicated by “straight”, “horizontal”, “inside”, “outside”, etc. are based on the orientations or positional relationships shown in the drawings and are only in order to facilitate the description of the present invention and simplify the description, it is not intended to indicate or imply that the device or element referred to must have a specific orientation, structure and operation in a specific orientation, therefore it cannot be construed as a limitation of the present invention. Furthermore, the term “section” and the terms “one”, “second”, and “third” are used for descriptive purposes only and are not to be construed as indicating or implying relative importance.

In this description, it should be noted that, unless otherwise clearly specified and limited, the terms “install” and “connect” should be understood in a broad sense. For example, they can refer to a fixed connection, a detachable connection, or an integral connection; as well as a mechanical connection or an electrical connection; and also a direct connection or an indirect connection through an intermediate medium. Alternatively, it can be an internal connection between two components. For those of ordinary skill in the art, the above terms can be understood in specific situations.

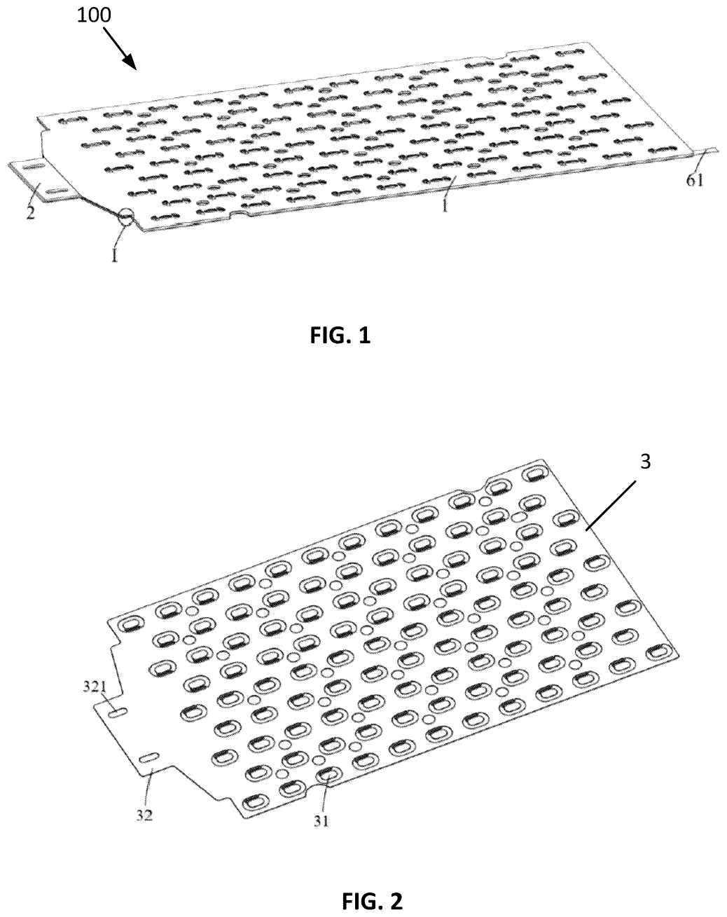

Illustratively, as shown in FIGS. 1 to 5, a current collector or bus plate includes a first insulating layer 1 and a strength or reinforcing layer 2, a bus layer 3 and a second insulating layer 4. The bus layer 3 is provided with a number of electrode connection parts 31, and reinforcement layer 2 includes spacers (spacers 2A and 2B are illustrated in FIG. 4). The first reinforcing plate 21 and the second reinforcing plate 22 form the strength layer 2 and are arranged in between the first insulating layer 1 and the second insulating layer 4. There is a first escape hole (not labeled) corresponding to the electrode connection part or portion 31.

In this technical solution, the peripheries of the first insulating layer 1 and the second insulating layer 4 protrude from the reinforcement layer 2 and the bus layer 3. When encapsulating by processes such as hot pressing, the number of second electrode connections depends on the number of cells/cylindrical cells in the battery module. The connection part is connected to the positive or negative electrode of the cell/cylindrical battery through welding, etc., and the reinforcing layer is made of 1.5 mm thick plate. To protect the bus layer, the reinforcement layer 2 is composed of a first reinforcement board or plate 21 and a second reinforcement board or plate 22 that are independent of each other. The bus board 3 can be installed along the first reinforcement board 21. The gap between the first reinforcing plate 21 and the second reinforcing plate 22 can be bent arbitrarily to facilitate installation. The gap between the first reinforcing plate 21 and the second reinforcing plate 22 is 3 mm. This prevents the first reinforcing plate 21 and the second reinforcing plate 22 from interfering with each other during the bending process.

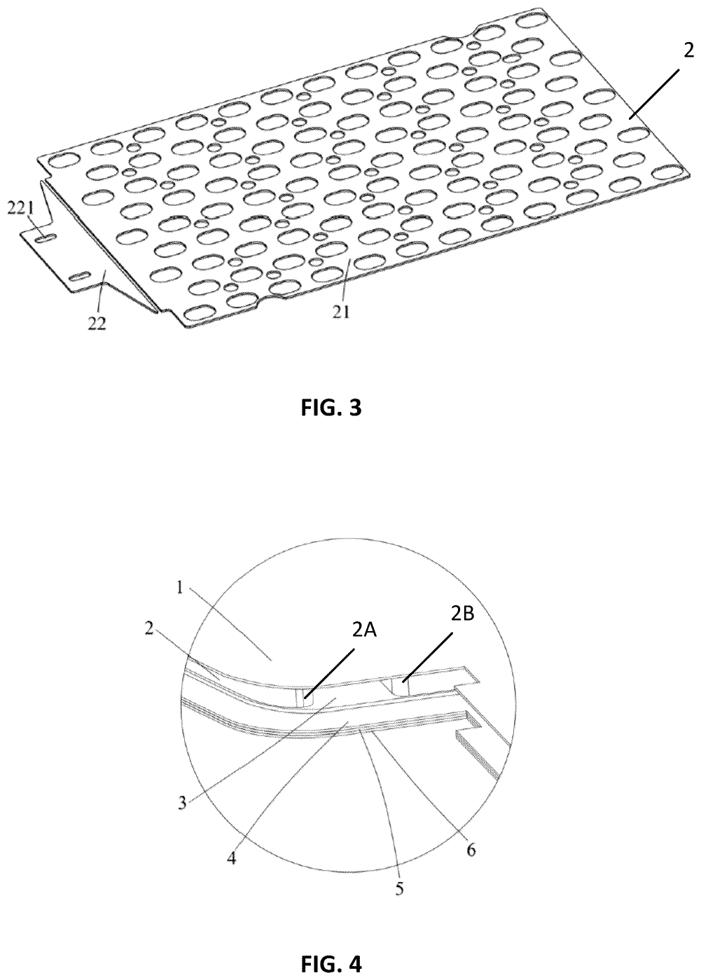

Illustratively, as shown in FIGS. 2 and 3, the bus layer 3 has a mounting part or portion 32 protruding from one end close to the second reinforcing plate 22. The mounting part 32 is provided with a first mounting hole 321, and the second reinforcing plate 22 is provided with a second mounting hole 221 that is coaxial with the first mounting hole 321.

In this technical solution, the second reinforcing plate 22 is used to protect the mounting portion 32 of the bus layer 3, and the battery core/cylindrical battery is welded to the bus layer 3. The bus plate 32 is fixed to other parts through the first mounting hole 321 and the second mounting hole 221.

Illustratively, both the first mounting hole 321 and the second mounting hole 221 are oval-shaped holes.

In this technical solution, the oval-shaped hole can reduce the dimensional accuracy required for assembly, has strong adaptability, and reduces processing difficulty.

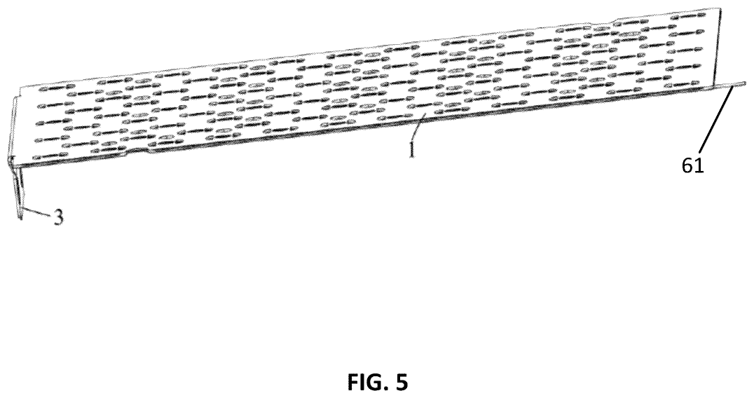

Illustratively, as shown in FIGS. 1 and 5, the mounting portion 32 and the second reinforcing plate 22 extend away from a portion of the first reinforcing plate 21. Both ends protrude from the first insulating layer 1 and the second insulating layer 4.

In this technical solution, the mounting portion 32 and the second reinforcing plate 22 can be directly connected to other parts.

Illustratively, as shown in FIG. 5, the side of the second insulating layer 4 facing away from the bus layer 3 is provided with an adhesive layer 5, and the adhesive layer 5 is provided with a peeling layer 6 on the side away from the second insulating layer 4, and a pair of electrode connecting portions 31 is provided in the adhesive layer 5 and the peeling layer 6. The corresponding second escape hole.

In this technical solution, the adhesive layer 5 can directly use double-sided tape, etc., during production, transportation and storage, and the peeling off the layer of protective adhesive. Adhesive layer 5 can be covered with peeling layer 6 to prevent the adhesive layer 5 from adhering to items in contact with it. When using, remove the peeling layer 6 so that the bus board 3 and battery core/column with the batteries are bonded to each other to avoid shaking.

For example, as shown in FIGS. 1 and 5, one end of the peeling layer 6 has a peeling strip 61 protruding.

In this technical solution, the peeling strip 61 is configured to facilitate manual removal of the peeling layer 6 and improve work efficiency.

Illustratively, as shown in FIGS. 3 and 4, the first insulating layer 1, the first reinforcing plate 21, the bus layer 3, the second insulating layer 4, the glue or adhesive layer 5 are aligned for the coaxial positioning of holes provided in the adhesive layer 5 and the peeling layer 6.

In this technical solution, the positioning holes are convenient for stacking the first insulating layer 1, the first reinforcing plate 21, the bus layer 3, and the second insulating layer 4, and ensure the mutual positioning of the layers, including the adhesive layers and release layers.

To sum up, the disclosed current collector has a simple structure, and the reinforcing layer 2 is composed of a first reinforcing plate 21 and a second reinforcing plate 22 that are independent of each other. The current collector 100 can be bent arbitrarily along the gap between the first reinforcing plate 21 and the second reinforcing plate 22 to facilitate installation.

It should be noted as used herein, the terms “include” or “including” and any variation thereof are intended to be non-exclusive and include additional elements, such that a process, method, article or equipment that includes a series of elements not only includes those elements, but and also includes other elements not expressly listed or inherent in such process, method, article or equipment elements. Without further limitation, elements qualified by the statement “includes a” are not excluded from inclusion of additional elements. There are other identical elements in the process, method, article or equipment that describe the elements mentioned above.

The above is only one implementation of a film according to the present invention. It should be understood that for one of ordinary skill in this technical field and in the related art, several improvements and modifications can be made without departing from the principles of the present invention. These improvements should be considered as included in the scope of this disclosure.

What is claimed is:

1. A bus plate, comprising:
a first insulating layer;
a reinforcement layer, the reinforcement layer including first reinforcement plates arranged at intervals and a second reinforcing plate;
a bus layer, the bus layer including a plurality of electrode connection parts; and
a second insulating layer, the first insulating layer, the reinforcement layer, the bus layer, and the second insulating layer being stacked in sequence, Wherein the first insulating layer, a first reinforcing plate and the second insulating layer are each provided with a pair of electrode connecting parts.

2. The bus plate according to claim 1, wherein one end of the bus layer close to the second reinforcing plate protrudes and includes a mounting portion, and a first mounting hole is provided in the mounting portion, and the first mounting hole is located coaxially with a second mounting hole provided in the second reinforcing plate.

3. The bus plate according to claim 2, wherein both the first mounting hole and the second mounting hole are oval-shaped holes.

4. The bus plate according to claim 2, wherein the mounting portion and the second reinforcing plate extend away from the first reinforcing plate, and one end of the second reinforcing plate protrudes from the first insulating layer and the second insulating layer.

5. The bus plate according to claim 1, wherein an adhesive layer is provided on a side of the second insulating layer facing away from the bus layer, a peeling layer is provided on a side of the adhesive layer facing away from the second insulating layer, and the adhesive layer and the peeling layer include a second relief hole corresponding to an electrode connection portion.

6. The bus plate according to claim 5, wherein a peeling strip protrudes from one end of the peeling layer.

7. The bus plate according to claim 5, wherein coaxial positioning holes are provided in the second insulating layer, the adhesive layer and the peeling layer.
